(19) United States
(12) Patent Application Publication
(10) Pub. No.: US 2012/0006830 A1
(43) Pub. Date: Jan. 12, 2012

(54) Infinite Wisdom Mug

(75) Inventor: Colleen L. LARREAU, Las Vegas, NV (US)

(73) Assignee: EDISON NATION, LLC, Charlotte, NC (US)

(21) Appl. No.: 13/217,028

(22) Filed: Aug. 24, 2011

Related U.S. Application Data
(63) Continuation of application No. 12/321,426, filed on Jan. 20, 2009.
(60) Provisional application No. 61/064,838, filed on Mar. 26, 2008.

(51) Int. Cl. A47J 41/00

(52) U.S. Cl. 220/592.17

(57) ABSTRACT

A portable beverage container includes a generally cylindrical outer shell comprising one or more metallic materials, the outer shell including a rim along a top portion thereof, the rim defining an opening to a hollow interior; a generally cylindrical removable liquid containment vessel including (i) an opening to an interior liquid storage chamber at a top portion thereof, and (ii) a lip surrounding the opening, the lip adapted to rest upon the rim when the liquid containment vessel is disposed within the hollow interior of the outer shell, the liquid containment vessel consisting of microwave-safe materials; and an insulating layer disposed between the outer shell and the removable liquid containment vessel. The liquid containment vessel is adapted to be removed from the hollow interior of the outer shell, heated in a microwave oven, and returned to the hollow interior of the outer shell.

### CROSS-REFERENCE TO RELATED APPLICATION

The present application is a U.S. continuation patent application of, and claims priority under 35 U.S.C. §120 to, U.S. nonprovisional patent application Ser. No. 12/321,426 (“the '426 application”), filed Jan. 20, 2009, which '426application published as U.S. patent application publication no. 2010/0038368, which '426 application and any patent application publications thereof are hereby incorporated by reference herein, and which '426 application is a U.S. nonprovisional patent application of, and claims priority under 35 U.S.C. §119(e) to, U.S. provisional patent application serial number 61/064,838, filed Mar. 26, 2008, which provisional patent application is hereby incorporated by reference herein.

### BACKGROUND OF THE INVENTION

This invention is a household appliance and convenience item. This invention addresses specific problems involved in the prior products. Standard travel mugs or thermoses may contain metal and layers of insulation. These substances work great for retaining heat, but are not microwave or dishwasher safe. In addition, if liquid contents are transferred to microwavable containers for reheating and back into travel mug or thermos when hot, a burn injury is quite possible.

### SUMMARY OF THE INVENTION

This invention is a dramatically improved version of a travel mug or thermos. This invention has a removable plastic or soy plastic liquid containment vessel (liner) that is safe for the microwave and the dishwasher. The ability to remove the liner and place it safely into the microwave is convenient and reduces burn injury. The removal of the liner has an added convenience of being dishwasher safe for easy cleaning and sanitizing.

### BRIEF DESCRIPTION OF THE DRAWINGS

FIG. 1A: Full view of intact mug;

FIG. 1B: View of intact mug with all layers visible;

FIG. 2A: View of removable liner detached from mug;

FIG. 3A: View of the locking mechanism;

FIG. 4A: View of lid-top view; and

FIG. 4B: View of lid-side view.

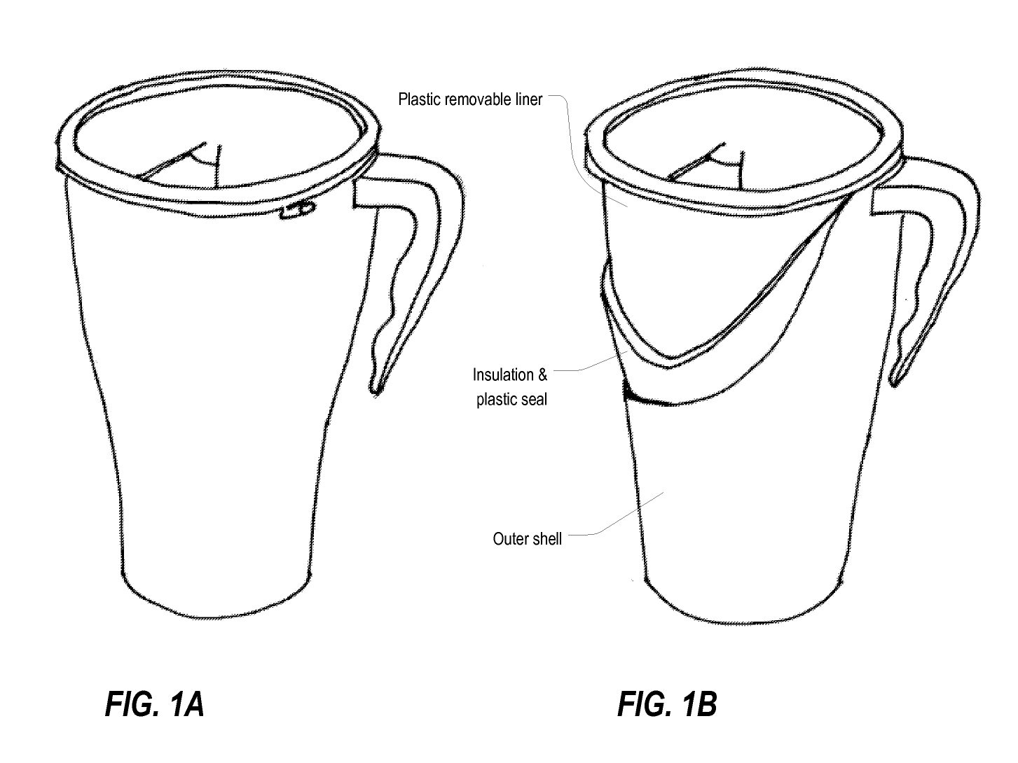

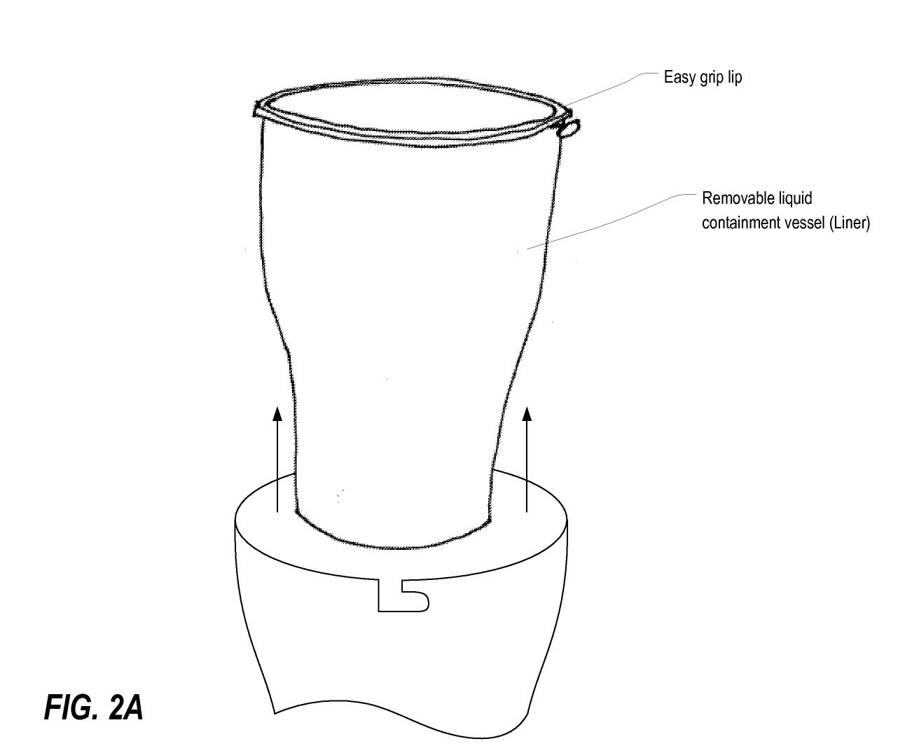

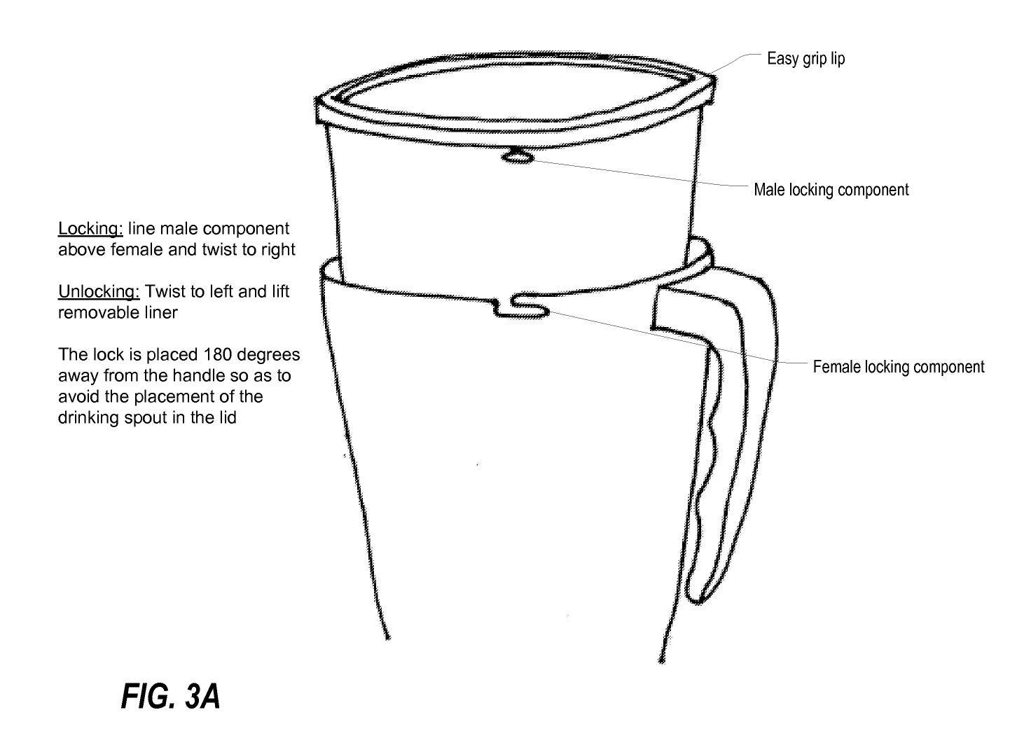

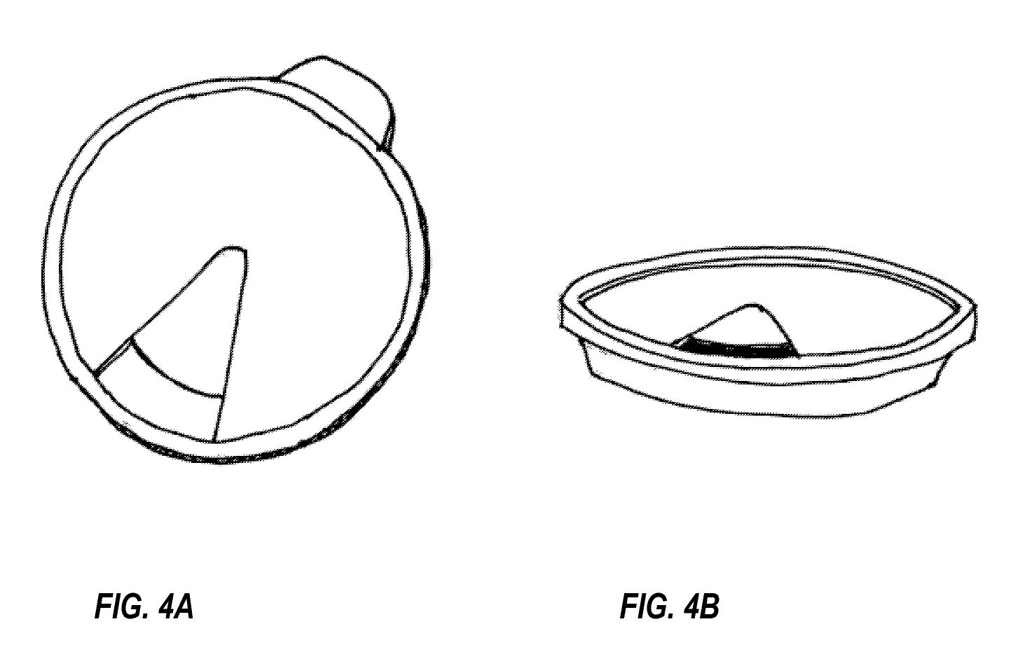

### DETAILED DESCRIPTION

This invention is of an insulated travel mug or thermos for liquids. This invention has three layers. The outer, and visible shell of the container is made of metal. Metal helps retain the desired temperature for longer.

The inner-most layer, designed for holding the liquid contents of the mug, is made of plastic or soy plastic. This plastic liner is removable. This liner is constructed with an “easy grip lip” so as to make gripping the liner for the removal process easy and safe. This lip is a thickened band of plastic around the top of the liner. This invention is also constructed with a locking mechanism to assure the liner remains in place until removal is desired. Twist the plastic liner slightly to the left and the male mechanism lines up with the female slot, and lifts right out. This removable liner is both dishwasher safe, and microwavable. Because this removable inner layer is microwavable, the transferring of re-heated liquids between microwavable containers is eliminated, and reduces the risk of a burn injury.

The middle layer, between the outer metal shell and removable liner, is a layer of insulation sealed in plastic. The insulation and seal can also be made with soy products.

This invention can also be equipped with a nice plastic handle, and a lid with a pour spout that can open and close to reduce spilling and leaking.

This travel mug or thermos stands separate from the traditional and numerous models because it is the only one with a removable liner that is microwavable and dishwasher safe. The insulation in other models makes them incapable of being placed in a dishwasher. The metal and steel make the other models incapable of being placed in a microwave. This invention solves each of these problems. The plastic or soy plastic liner in this invention is simply removed and popped into the microwave for re-heating, or into the dishwasher for cleaning and sanitizing. The ability to place this liner into the microwave without having to pour the contents into a microwavable container and back into the travel mug or thermos reduces the risk of burn injury.

1. A portable beverage container, comprising:
(a) a generally cylindrical outer shell comprising one or more metallic materials, the outer shell including a rim along a top portion thereof, the rim defining an opening to a hollow interior;
(b) a generally cylindrical removable liquid containment vessel including (i) an opening to an interior liquid storage chamber at a top portion thereof, and (ii) a lip surrounding the opening, the lip adapted to rest upon the rim when the liquid containment vessel is disposed within the hollow interior of the outer shell, the liquid containment vessel consisting of microwave-safe materials; and
(c) an insulating layer disposed between the outer shell and the removable liquid containment vessel;
(d) wherein the liquid containment vessel is adapted to be removed from the hollow interior of the outer shell, heated in a microwave oven, and returned to the hollow interior of the outer shell.

2. The portable beverage container of claim 1, wherein the liquid containment vessel comprises one or more plastic materials.

3. The portable beverage container of claim 1, wherein the liquid containment vessel comprises soy plastic.

4. The portable beverage container of claim 1, wherein the portable beverage container consists of dishwasher-safe materials.

5. The portable beverage container of claim 1, wherein the insulating layer comprises one or more gases.

6. The portable beverage container of claim 1, wherein the insulating layer comprises soy products.

7. The portable beverage container of claim 1, wherein the insulating layer comprises solid insulating material.

8. The portable beverage container of claim 1, wherein the insulating layer is sealed in plastic.

9. The portable beverage container of claim 1, wherein the outer shell further comprises a handle.

10. The portable beverage container of claim 1, further comprising a lid.

11. The portable beverage container of claim 10, wherein the lid includes a closable dispensing opening for dispensing liquid housed within the liquid storage chamber.

12. The portable beverage container of claim 1, further comprising a safety locking mechanism to prevent accidental removal of the liquid containment vessel from the outer shell.

13. The portable beverage container of claim 12, wherein the safety locking mechanism includes an L-shaped slot on the outer shell proximate the rim and a radially extruding pin on the liquid containment vessel proximate the lip.

14. A portable beverage container, comprising:
(a) a generally cylindrical outer shell comprising one or more metallic materials, the outer shell including (i) a rim along a top portion thereof, the rim defining an opening to a hollow interior, and (ii) an L-shaped slot proximate the rim;
(b) a generally cylindrical removable liquid containment vessel including (i) a lip at a top portion thereof, the lip adapted to rest upon the rim when the liquid containment vessel is disposed within the hollow interior of the outer shell, and (ii) an outwardly-extruding pin proximate the lip, the liquid containment vessel consisting of microwave-safe materials; and
(c) an insulating layer disposed between the outer shell and the removable liquid containment vessel;
(d) wherein the liquid containment vessel is removably secured to the outer shell by vertically inserting the pin into the L-shaped slot and rotating the liquid containment vessel.

15. The portable beverage container of claim 14, wherein the liquid containment vessel comprises one or more plastic materials.

16. The portable beverage container of claim 14, wherein the liquid containment vessel comprises soy plastic.

17. The portable beverage container of claim 14, wherein the portable beverage container consists of dishwasher-safe materials.

18-21. (canceled)

24. The portable beverage container of claim 14, wherein the outer shell further comprises a handle.

22. The portable beverage container of claim 14, further comprising a lid.

23. The portable beverage container of claim 22, wherein the lid includes a closable dispensing opening for dispensing liquid housed within the liquid storage chamber.
